(19) United States
(12) Patent Application Publication
(10) Pub. No.: US 2017/0228502 A1
(43) Pub. Date: Aug. 10, 2017

(54) Systems, Devices, and/or Methods for Managing Medical Information

(71) Applicant: Gaelen John Rickard, Charlottesville, VA (US)

(72) Inventor: Gaelen John Rickard, Charlottesville, VA (US)

(21) Appl. No.: 15/430,310

(22) Filed: Feb. 10, 2017

Related U.S. Application Data
(60) Provisional application No. 62/293,604, filed on Feb. 10, 2016.

(51) Int. Cl. G06F 19/00; H04W 4/00

(52) U.S. Cl. CPC G06F 19/327; H04W 4/008; G06F 19/322; H04W 88/02

(57) ABSTRACT

Certain exemplary embodiments can provide a method, which comprises automatically assigning an emergency room suite based upon patient information. The patient information is transmitted via a wireless signal from an emergency services entity to an entity managing the emergency room suite. The patient information comprising information inputted by one or more personnel of the emergency services entity.

### CROSS-REFERENCES TO RELATED APPLICATIONS

This application claims priority to, and incorporates by reference herein in its entirety, pending U.S. Provisional Patent Application Ser. No. 62/293,604 (Attorney Docket No. 1103-01), filed Feb. 10, 2016.

### BRIEF DESCRIPTION OF THE DRAWINGS

A wide variety of potential embodiments will be more readily understood through the following detailed description of certain exemplary embodiments, with reference to the accompanying exemplary drawings in which:

FIG. 1 is a block diagram of an exemplary embodiment of a system 1000;

FIG. 1A is a block diagram of an exemplary embodiment of a system;

FIG. 2 is an exemplary embodiment of an information flow diagram 2000;

FIG. 3 is an exemplary embodiment of a user interface image 3000;

FIG. 4 is a flowchart of an exemplary embodiment of a method 4000;

FIG. 4A is a flowchart of an exemplary embodiment of a method;

FIG. 5 is a block diagram of an exemplary embodiment of an information device 5000;

FIG. 6 is a process diagram of an exemplary embodiment of an EMS PreAlert Mobile Device App 6000; and

FIG. 7 is a process diagram of an exemplary embodiment of a system 7000.

### DETAILED DESCRIPTION

Certain exemplary embodiments can provide a method, which comprises automatically assigning an emergency room suite based upon patient information. The patient information is transmitted via a wireless signal from an emergency services entity to an entity managing the emergency room suite. The patient information comprising information inputted by one or more personnel of the emergency services entity.

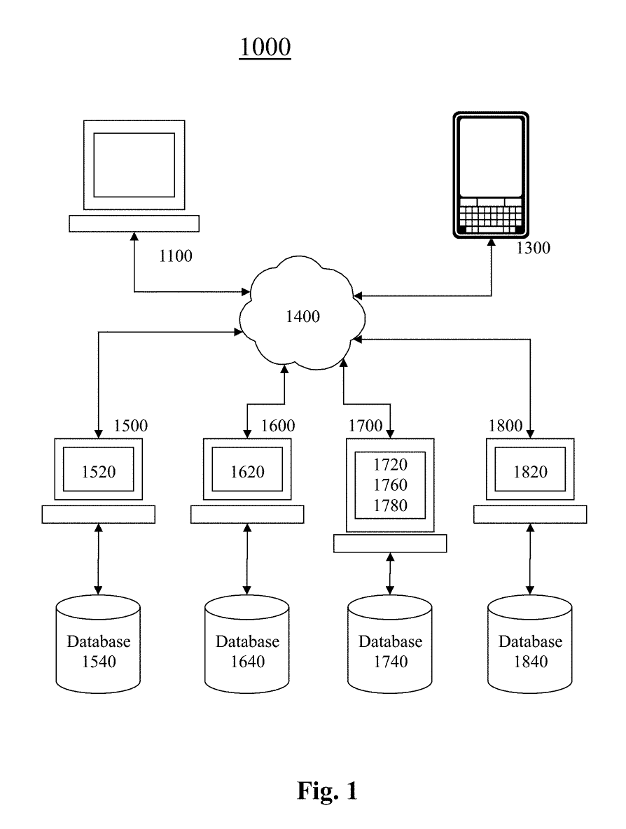

FIG. 1 is a block diagram of an exemplary embodiment of a system 1000, which can comprise a smartphone 1300, an information device 1100, a network 1400, a first server 1500, a second server 1600, a third server 1700, and a fourth server 1800. First server 1500 can comprise a first user interface 1520 and can be coupled to a first database 1540. Second server 1600 can comprise a second user interface 1620 and can be coupled to a second database 1640. Third server 1700 can comprise a third user interface 1720, a processor 1760, machine instructions 1780, and can be coupled to a third database 1740. Fourth server 1800 can comprise a fourth user interface 1820 and can be coupled to a fourth database 1840. Any of the methods and/or steps thereof can be carried out in whole or in part by smartphone 1300, information device 1100 and/or first server 1500. Second server 1600, third server 1700, and/or fourth server 1800 can each be associated with administration and allocation of patient treatment resources by a medical treatment facility, such as a hospital, supporting data for which is stored in memory devices coupled thereto. In certain exemplary embodiments, system 1000 can be used to implement one or more methods disclosed herein.

FIG. 1A is a block diagram of an exemplary embodiment of a system, which can utilize and emergency medical services (“EMS”) PreAlert App. The EMS PreAlert App can be executed on any information device such as, for example, a smart phone, tablet, laptop computer, and/or desktop computer, etc. EMS PreAlert App can provide a user interface for an EMS provider to provide and/or exchange information as further detailed herein, infra, with a hospital and/or medical facility. The EMS PreAlert App can communicate with a server. The server can be constructed to send e-mail and/or otherwise communicate with the EMS provider and/or medical services personnel. The server can be constructed to export information obtained from the EMS PreAlert App to one or more external databases. The server can be constructed to communicate with a client database, which in turn can communicate with an EMS PreAlert display system (that renders representations of data received from the client database) and/or an emergency response (“ER”) manager system. The ER manager system can assign and/or render a bay assignment for an emergency facility (e.g., a hospital emergency room) and/or communicate with an ER manager command center.

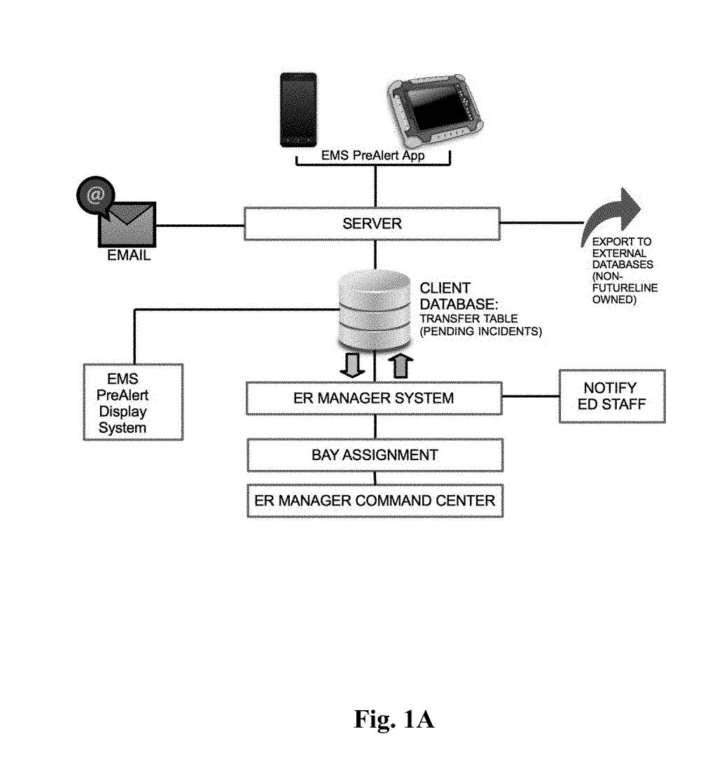

FIG. 2 is an exemplary embodiment of an information flow diagram 2000, which comprises a schematic diagram of three classes associated with hospital emergency room patients. Patients seeking emergent care at a hospital can be classified in one of three categories. For example, Pool A can comprise patients with an emergent condition that should be seen and treated by a medical professional immediately. Pool B can comprise patients with an urgent condition that should be seen and treated by a medical professional relatively quickly, but do not have a condition that is life-threatening in the sense that a delay of a few minutes would result in serious consequences. Pool C can comprise patients with a nonurgent condition that should be seen and treated by a medical professional, but can wait for a relatively long time without significant adverse consequences. Hospitals and emergency response professionals can utilize wireless communications between information devices to plan and assign resources prior to the arrival of a patient at a hospital.

Hospitals can utilize a dynamic resource allocation system that is administered via a set of networked servers and information devices, such as the set of networked servers and information devices illustrated in FIG. 1. For example, a particular hospital might have 36 patient suites in an emergency room and can manually or dynamically allocate a first subset of the suites (e.g., 8 patient suites) to Pool A patients, a second subset of the suites (e.g., 14 patient suites) to Pool B patients, and a third subset of the suites (e.g., 14 patient suites) to Pool C patients. A human administrator of the hospital and/or a supervisory information device (e.g., an information device illustrated in FIG. 1) can reallocate emergency room suites to different categories based upon patient needs and/or available medical resources on a given day at a given time.

In certain exemplary embodiments, the hospital can have a rendered status board for the emergency room, which illustrates usage and/or planned use of emergency room suites. The status board can be updated automatically and/or via manual intervention by a human.

Emergency response professionals often transport patients to hospitals. The emergency response professionals can take patient readings and assessments in preparing to transport and/or transporting patients to a medical treatment facility such as an emergency room at a hospital. The readings and assessments can be automatically and/or manually transferred via a wirelessly transmitting information device (e.g., a smart phone and/or tablet). Patients can be automatically and/or with intervention by emergency response professionals and/or hospital professionals categorized into Pool A, Pool B, or Pool C.

Certain exemplary embodiments can comprise an automatic mode and a manual mode for allocating resources. When in the manual mode a human, such as an emergency room physician, can categorize the patient into one of Pool A, Pool B, or Pool C and/or can assign an emergency suite and/or other resources for treatment. When in automatic mode, an information device categorizes the patient into one of Pool A, Pool B, or Pool C and/or can assign an emergency suite and/or other resources for treatment.

The wirelessly transmitting information device can automatically detect a closest hospital and transmit the patient readings and assessments to one or more information devices of the hospital. Based upon the transmitted patient readings and assessments, the hospital can automatically assign an emergency suite to an incoming patient and send notices to emergency personal concerning the impending patient arrival such that medical equipment, personnel, medications, and other hospital resources can be prepared for the patient arrival. For example, in certain exemplary embodiments, one or more e-mails can be sent to physicians, nurses, clerical personnel, and/or emergency room staff concerning the patient.

Certain notifications can request and/or demand a responsive communication (e.g., a call back) from the hospital to emergency response professionals. Such communications and preparations can be particularly important in when a patient is in an emergent and life threatening condition. Under such circumstances, preparation for the patient by the hospital might make a difference in patient survival.

A server or information device of a hospital can make decisions and/or can reallocate resources based upon the transmitted patient readings and assessments. For example, if a Pool A patient is being transported by emergency response professionals to the hospital and all Pool A suites at the hospital are being used, the server or information device of the hospital can determine that the hospital has sufficient resources to treat the patient and allocate a suite previously assigned to Pool B or Pool C to Pool A and communicate resource needs for the reassigned suite and/or the patient to hospital personnel. In other circumstances, if the hospital lack sufficient resources to treat the patient, the hospital can communicate with the wirelessly transmitting information device of the emergency response professionals and advise the emergency response professionals that the hospital cannot accept the patient and that the patient should be transported to an alternative hospital that has sufficient resources to treat the patient.

The hospital information management system can also be dynamically updated as emergency room resources are allocated to walk-in patients, which are also categorized in one of Pool A, Pool B, or Pool C.

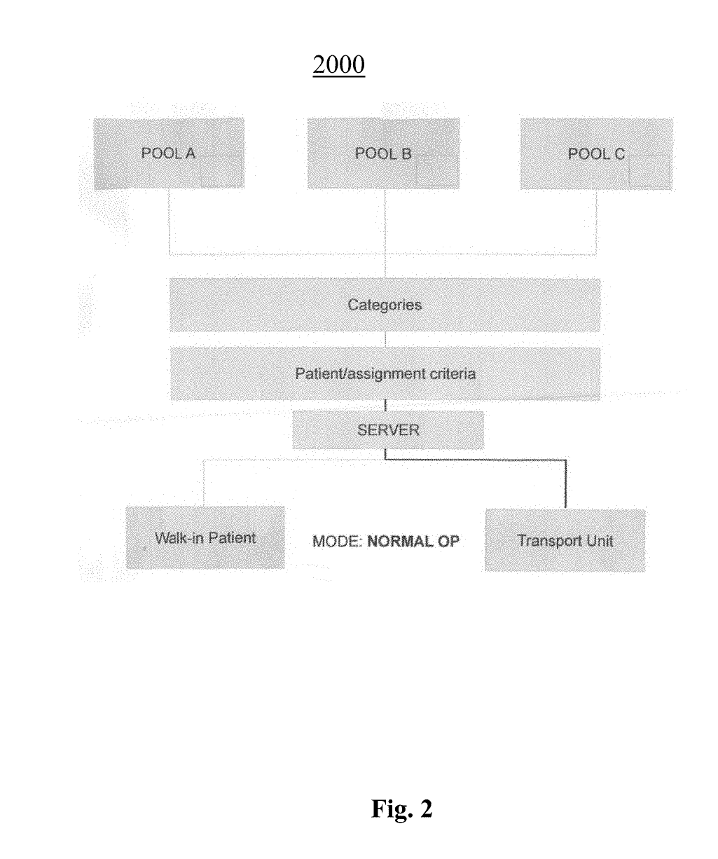

FIG. 3 is an exemplary embodiment of a user interface image 3000 from an input/output device. User interface image 3000 illustrates information comprising a date that the output was generated, a time when the information was sent to a hospital, an identification number associated with the transmission to the hospital, and patient information. In the illustrated example, the transporting unit is identified, the approximate arrival time at the hospital is indicated, the category of the patient (i.e., Alpha—which can be the equivalent of a Pool A classification for the patient), information concerning the vital signs of the patient, the physical condition of the patient, the cause of the patient's medical problems (i.e., “MVA” as an abbreviation for motor vehicle accident), a bay assignment (e.g., an assignment of an emergency room suite), a call back number for an emergency response professional with the patient, and information concerning other patients that the emergency room can expect from an incident giving rise to the patient's medical problems (i.e., in this case a motor vehicle accident).

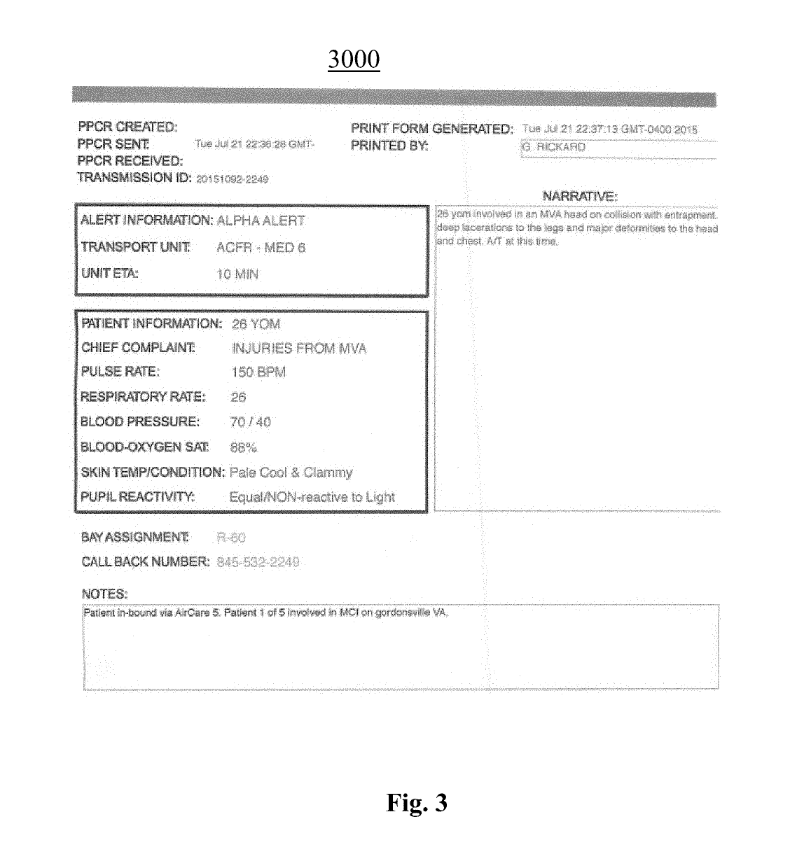

FIG. 4 is a flowchart of an exemplary embodiment of a method 4000. At activity 4100, a communication requesting medical assistance can be received from a patient and/or someone reporting that the patient desires medical assistance. At activity 4200, the patient can be picked up, for example, by emergency response professionals.

At activity 4300, patient data can be obtained from patient sensors and or manual measurements of the patient. The patient information can comprise information inputted by one or more personnel of the emergency services entity. In certain exemplary embodiments, machine instructions can be used to validate the patient information prior to transmittal of a wireless signal comprising the patient information. In certain exemplary embodiments, a document associated with the patient can be scanned and/or can be caused to be scanned for a portion of the patient information. In certain exemplary embodiments, a prescription associated with the patient can be scanned and/or can be caused to be scanned for a portion of the patient information. In certain exemplary embodiments, a sensor information associated with the patient to be automatically obtained and/or can be caused to be obtained for a portion of the patient information. The patient information can comprise a vital sign of the patient such as from a sensor via a Bluetooth signal.

At activity 4400, the patient data can be transmitted to an information device or server at a medical treatment facility, such as a hospital. The patient information can transmitted via a wireless signal from an emergency services entity to an entity managing the emergency room suite. In certain exemplary embodiments, the wireless signal is transmitted via a smartphone.

At activity 4500, an emergency room suite can be reserved responsive to the transmitted patient data. A facility comprising the emergency room suite can be automatically selected based upon an automatically detected location of the patent and a location of the emergency room suite. In certain exemplary embodiments, an emergency room suite is automatically assigned based upon patient information. The emergency room suite can be approved by a second user entering approval via a user interface. The patient can be automatically assigned to a class of emergency patients based upon the patient information

At activity 4600, patient condition data can be received by emergency services personnel such that personnel and/or other resources can be available upon the arrival of the patient and the medical treatment facility. A server associated with the emergency room suite can acknowledge receipt of the patient information and provides the emergency services entity with an incident number assigned to a patient based upon the patient information. The server can create a history of the patient information and places the patient information in a transfer table. Information from the transfer table can be rendered to a first user associated with the emergency room suite to facilitate treatment. In certain exemplary embodiments, once treatment is complete, the patient information can be caused to be automatically erased from the transfer table.

At activity 4700, emergency response professionals and/or others can deliver the patient to the emergency room suite. The patient can be caused to be placed in the emergency room suite upon arrival of the patient to a facility comprising the emergency room suite.

At activity 4800, the patient can be treated responsive to the information transmitted to the information device or server. Certain exemplary embodiments can automatically cause a Staff Alert to be transmitted based upon the patient information. Certain exemplary embodiments can automatically cause information to be rendered to emergency room staff based upon the patient information.

FIG. 4A is a flowchart of an exemplary embodiment of a method. The method comprises:
an EMS provider inputting patient vital information;
an EMS PreAlert App that validates data and submits the data to a server;
the server acknowledges the data transmission and returns and incident number;
the server creates a history record of data and places it into a transfer table;
an EMS preAlert display system (“DS”) and ER Manager monitor for, and/or receive data concerning, new incidents—if a new incident is entered into a database, data concerning the incident is communicated with the EMS preAlert DS and the ER Manager;
the ER Manager processes data—if in an automatic mode, a room assignment function is run to obtain a bay assignment for an incoming patient and the bay assignment is communicated to the EMS PreAlert App; and/or
if the ER Manager is not in the automatic mode, the incident is left unapproved and it is left to personnel (e.g., a charge nurse) to approve a request for a bay and/or update the system.

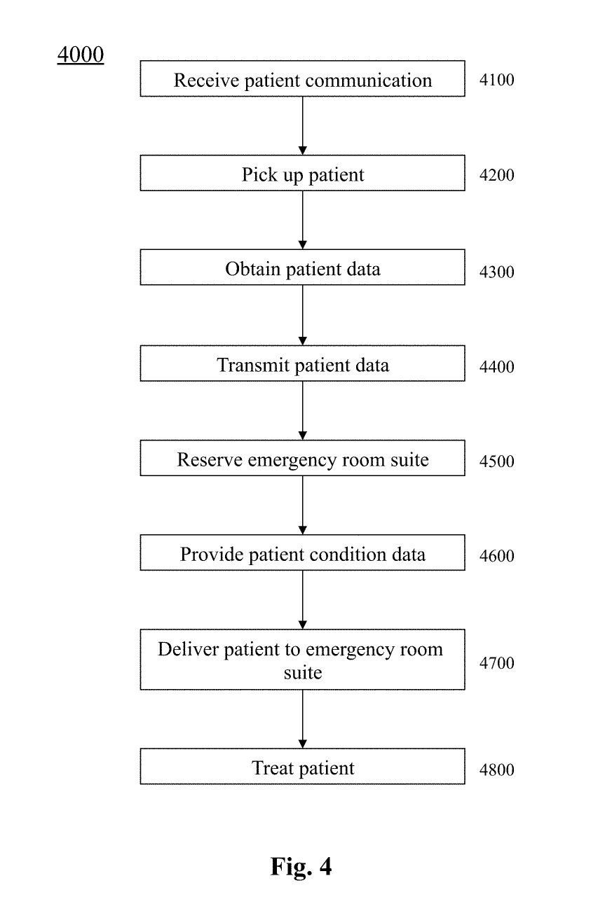

FIG. 5 is a block diagram of an exemplary embodiment of an information device 5000, which in certain operative embodiments can comprise, for example, first server 1500 and information device 1100 of FIG. 1. Information device 5000 can comprise any of numerous circuits and/or components, such as for example, one or more network interfaces 5100, one or more processors 5200, one or more memories 5300 containing instructions 5400, one or more input/output (I/O) devices 5500, and/or one or more user interfaces 5600 coupled to I/O device 5500, etc.

In certain exemplary embodiments, via one or more user interfaces 5600, such as a graphical user interface, a user can view a rendering of information related to specifying, ordering, designing, selling, manufacturing, and/or delivering a product such as an electric motor.

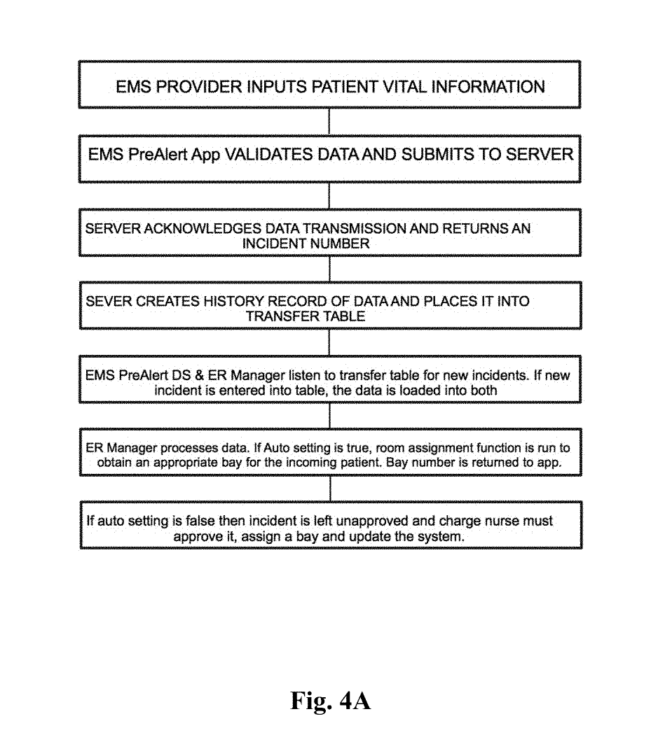

FIG. 6 is a process diagram of an exemplary embodiment of an EMS PreAlert Mobile Device App 6000, which comprises machine instructions executing an automated method of acquiring patient personal information. Element 6100 comprises machine instructions to utilize a camera of an information device to scan a PDF417 barcode on a patient's government issued ID (e.g., a driver's license).

Element 6400 comprises machine instructions to enter data manually (e.g., by the EMS provider). This results in a PPCR being routed to a hospital facility as well as a patient's chief complaint and a narrative of the patient and/or EMS provider. Element 6500 comprises machine instructions that receive and/or generate information of the transport unit, agency and/or provider information that the app adds to the PPCR before transmitting the PPCR. This information can be entered via a settings section of the app.

Element 6300 comprises machine instructions to automatically receive patient vital signs from equipment that monitors such vital signs. Element 6300 can automatically pair the app with a cardiac monitor via Bluetooth and transfer the patient's vital signs to EMS PreAlert and load the vital signs into the PPCR automatically.

Element 6300 comprises machine instructions to scan drug information. This feature allows a provider to scan drugs being administered to the patient rapidly and automatically add them to the PPCR.

Element 6300 comprises machine instructions to transmit PPCR information from the app. Element 6300 is able to check over the routing location of the PPCR and verify his or her contact information. Upon pushing the transmit button, the app will verify the information and upload the complete PPCR to the server where it will be routed to both the agency database, element 6900, and the Hospital Facility database, element 6950.

Upon transmitting the PPCR via cellular data or Wi-Fi and a secure encrypted connection, element 6700, the server will reply to the app with an assigned incident number, element 6800. Upon receiving the incident number, the app stores it as a reference for that transmitted and now pending PPCR. The app will now continue to listen for alerts and information from the facility via element 6800.

EMS PreAlert is an app designed to take all desired inputted patient data during an EMS transport and generate a digital PPCR and then transmit that PPCR to a Futureline Systems Hospital Receiving terminal. The hospital receiving terminal is designed solely for use with EMS PreAlert. The data comprises personal data for the patient, the patient's vital signs, and other medical information.

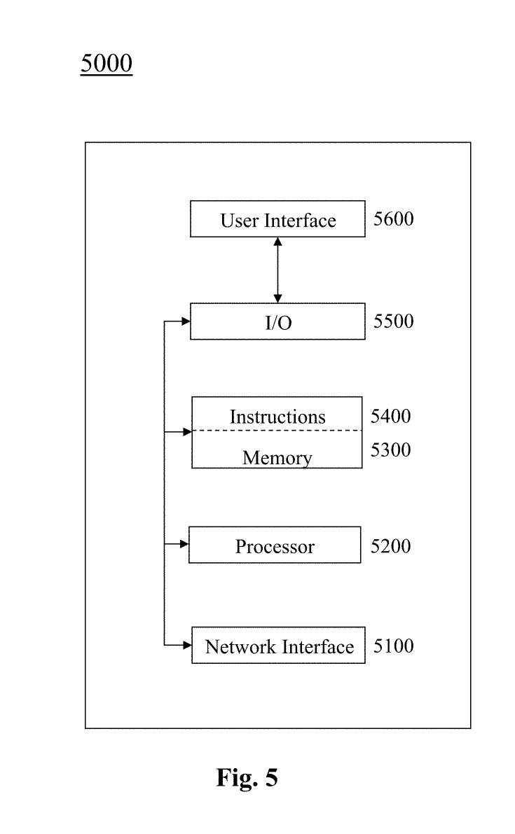

FIG. 7 is a process diagram of an exemplary embodiment of a system 7000. At activity 7100, an ER Terminal (i.e., information device) can receive a new PPCR from an EMS PreAlert user, process the data, and render it on a user interface.

At activity 7600, upon receiving an interface request from an in-bound transport unit. The user can be prompted to dispatch the request as a Staff Alert or an SMS or to open locally on the existing information device.

If ER Manager (i.e., information device) is on, at activity 7250, upon receiving the PPCR the system can dispatch Staff Alerts and SMS alerts based on what the PPCR criteria calls for. For example, if a ST-Elevation myocardial infarction (“stemi alert”) is received and the criteria supports it, the system can be set to notify the catheterization lab and the code team. The system can then find an appropriate bay for the patient that has the correct equipment in correspondence with the PPCR criteria and alert the providers via EMS PreAlert.

At activity 7200, if ER Manager is off, upon receiving a PPCR the information device can cause a general Staff Alert and/or SMS alert to be dispatched, thereby notifying the nursing staff that a new PPCR has been transmitted to the hospital, which needs the nursing staff's attention.

At activity 7300, the information device can wait for nursing staff to approve or deny the requested patient condition/alert and/or enter in a room assignment. Upon entering data, the providers can be alerted via EMS PreAlert.

At activity 7400, upon the patient arriving the charge nurse can scan a QR Code via an information device (e.g., the provider's smartphone) generated by EMS PreAlert. This can cause substantially all of the patient registration data to be imported into a database via an information device and can trigger the information device to admit the patient and move the patient's information into the hospital control system at activity 7500.

At activity 7500, a facility database can be searched for a PPCR ID and the PPCR ID can be transferred from a Receiving Terminal (i.e., information device) to and ER Control panel (i.e., information device). The record can then be erased from a transfer table.

### Definitions

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
acknowledge—to send a response indicating that a transmitted message was received uncorrupted or without errors or that a receiving station is ready to accept transmissions.
activity—an action, act, step, and/or process or portion thereof
agency—an entity that provides EMS care and transportation.
and/or—either in conjunction with or in alternative to.
apparatus—an appliance or device for a particular purpose.
approve—to give something official agreement or acceptance.
arrive—to get to a place.
assign—to set something aside for a patient.
associate—to join, connect together, and/or relate.
automatically—acting or operating in a manner essentially independent of external influence or control. For example, an automatic light switch can turn on upon “seeing” a person in its view, without the person manually operating the light switch.
bay—a patient treatment space in an emergency room divided from other portions of the emergency room by walls and/or curtains.
Bluetooth—a wireless technology standard for exchanging data over short distances (using short-wavelength UHF radio waves in the ISM band from 2.4 to 2.485 GHz) from fixed and mobile devices, and building personal area networks.
can—is capable of, in at least some embodiments.
circuit—an electrically conductive pathway and/or a communications connection established across two or more switching devices comprised by a network and between corresponding end systems connected to, but not comprised by the network.
comprising—including but not limited to.
configure—to make suitable or fit for a specific use or situation.
constructed to—made suitable or fit for a specific use or situation.
convert—to transform, adapt, and/or change.
data—distinct pieces of information, usually formatted in a special or predetermined way and/or organized to express concepts.
data structure—an organization of a collection of data that allows the data to be manipulated effectively and/or a logical relationship among data elements that is designed to support specific data manipulation functions. A data structure can comprise meta data to describe the properties of the data structure. Examples of data structures can include: array, dictionary, graph, hash, heap, linked list, matrix, object, queue, ring, stack, tree, and/or vector.
define—to establish the outline, form, or structure of
detect—to sense or perceive.
determine—to obtain, calculate, decide, deduce, and/or ascertain.
device—a machine, manufacture, and/or collection thereof.
document—a physical and/or electronic collection of related data elements. If physical, a document comprises one or more sheets of paper and the related data elements printed thereon. A document can be and/or represent a record of a patient encounter with a healthcare organization.
emergency patient—a person receiving treatment for a suspected acute illness, trauma, or other medical emergency.
emergency room staff—one or more persons responsible for the prompt treatment of acute illness, trauma, or other medical emergencies.
emergency room suite—a partitioned space in a medical facility that is equipped and staffed for the prompt treatment of acute illness, trauma, or other medical emergencies.
emergency services entity—a person or business entity equipped and staffed for the prompt transportation and/or treatment of acute illness, trauma, or other medical emergencies.
enter—to submit to an information device.
entity—a person or business.
erase—to delete from a memory device.
estimate—to calculate and/or determine approximately and/or tentatively.
facility—a hospital facility that receives patients and provides medical care for those patients.
generate—to create, produce, give rise to, and/or bring into existence.
haptic—involving the human sense of kinesthetic movement and/or the human sense of touch. Among the many potential haptic experiences are numerous sensations, body-positional differences in sensations, and time-based changes in sensations that are perceived at least partially in non-visual, non-audible, and non-olfactory manners, including the experiences of tactile touch (being touched), active touch, grasping, pressure, friction, traction, slip, stretch, force, torque, impact, puncture, vibration, motion, acceleration, jerk, pulse, orientation, limb position, gravity, texture, gap, recess, viscosity, pain, itch, moisture, temperature, thermal conductivity, and thermal capacity.
history—information about past events.
incident number—a reference number or a reference alphanumeric associated with a patient's emergent condition.
information—data that has been organized to express concepts.
information device—any device capable of processing data and/or information, such as any general purpose and/or special purpose computer, such as a personal computer, workstation, server, minicomputer, mainframe, supercomputer, computer terminal, laptop, wearable computer, and/or Personal Digital Assistant (PDA), mobile terminal, Bluetooth device, communicator, “smart” phone (such as a Treo-like device), messaging service (e.g., Blackberry) receiver, pager, facsimile, cellular telephone, a traditional telephone, telephonic device, a programmed microprocessor or microcontroller and/or peripheral integrated circuit elements, an ASIC or other integrated circuit, a hardware electronic logic circuit such as a discrete element circuit, and/or a programmable logic device such as a PLD, PLA, FPGA, or PAL, or the like, etc. In general any device on which resides a finite state machine capable of implementing at least a portion of a method, structure, and/or or graphical user interface described herein may be used as an information device. An information device can comprise components such as one or more network interfaces, one or more processors, one or more memories containing instructions, and/or one or more input/output (I/O) devices, one or more user interfaces coupled to an I/O device, etc.
input—to provide a signal, data, and/or information to a processor.
input/output (I/O) device—any sensory-oriented input and/or output device, such as an audio, visual, haptic, olfactory, and/or taste-oriented device, including, for example, a monitor, display, projector, overhead display, keyboard, keypad, mouse, trackball, joystick, gamepad, wheel, touchpad, touch panel, pointing device, microphone, speaker, video camera, camera, scanner, printer, haptic device, vibrator, tactile simulator, and/or tactile pad, potentially including a port to which an I/O device can be attached or connected.
location—a place substantially approximating where something physically exists.
machine instructions—directions adapted to cause a machine, such as an information device, to perform one or more particular activities, operations, or functions. The directions, which can sometimes form an entity called a “processor”, “kernel”, “operating system”, “program”, “application”, “utility”, “subroutine”, “script”, “macro”, “file”, “project”, “module”, “library”, “class”, and/or “object”, etc., can be embodied as machine code, source code, object code, compiled code, assembled code, interpretable code, and/or executable code, etc., in hardware, firmware, and/or software.
machine readable medium—a physical structure from which a machine can obtain data and/or information. Examples include a memory, punch cards, etc.
manage—to handle, direct, govern, or control in action.
may—is allowed and/or permitted to, in at least some embodiments.
memory device—an apparatus capable of storing analog or digital information, such as instructions and/or data. Examples include a non-volatile memory, volatile memory, Random Access Memory, RAM, Read Only Memory, ROM, flash memory, magnetic media, a hard disk, a floppy disk, a magnetic tape, an optical media, an optical disk, a compact disk, a CD, a digital versatile disk, a DVD, and/or a raid array, etc. The memory device can be coupled to a processor and/or can store instructions adapted to be executed by processor, such as according to an embodiment disclosed herein.
method—a process, procedure, and/or collection of related activities for accomplishing something.
network—a communicatively coupled plurality of nodes. A network can be and/or utilize any of a wide variety of sub-networks, such as a circuit switched, public-switched, packet switched, data, telephone, telecommunications, video distribution, cable, terrestrial, broadcast, satellite, broadband, corporate, global, national, regional, wide area, backbone, packet-switched TCP/IP, Fast Ethernet, Token Ring, public Internet, private, ATM, multi-domain, and/or multi-zone sub-network, one or more Internet service providers, and/or one or more information devices, such as a switch, router, and/or gateway not directly connected to a local area network, etc.
network interface—any device, system, or subsystem capable of coupling an information device to a network. For example, a network interface can be a telephone, cellular phone, cellular modem, telephone data modem, fax modem, wireless transceiver, Ethernet card, cable modem, digital subscriber line interface, bridge, hub, router, or other similar device.
patient—a human or other type of animal under supervision for health care purposes.
personnel—one or more persons employed by an organization.
place—to put something in a predetermined location.
portion—a part of a whole.
plurality—the state of being plural and/or more than one.
pending PPCR—a PPCR that has been sent and received by a hospital facility from the transport unit while the unit is still en route to the hospital facility.
PPCR—a pre-hospitalization patient care report.
predetermined—established in advance.
prescription—a written order for medicine and/or medicine provided based upon the written order.
prior to—earlier in time.
processor—a device and/or set of machine-readable instructions for performing one or more predetermined tasks. A processor can comprise any one or a combination of hardware, firmware, and/or software. A processor can utilize mechanical, pneumatic, hydraulic, electrical, magnetic, optical, informational, chemical, and/or biological principles, signals, and/or inputs to perform the task(s). In certain embodiments, a processor can act upon information by manipulating, analyzing, modifying, converting, transmitting the information for use by an executable procedure and/or an information device, and/or routing the information to an output device. A processor can function as a central processing unit, local controller, remote controller, parallel controller, and/or distributed controller, etc. Unless stated otherwise, the processor can be a general-purpose device, such as a microcontroller and/or a microprocessor, such the Pentium IV series of microprocessor manufactured by the Intel Corporation of Santa Clara, Calif. In certain embodiments, the processor can be dedicated purpose device, such as an Application Specific Integrated Circuit (ASIC) or a Field Programmable Gate Array (FPGA) that has been designed to implement in its hardware and/or firmware at least a part of an embodiment disclosed herein.
project—to calculate, estimate, or predict.
provide—to furnish, supply, give, and/or make available.
QR code—short for “Quick Response Code” is a type of matrix barcode (or two-dimensional barcode). A barcode is a machine-readable optical label that contains information about the item to which it is attached. A QR code uses four standardized encoding modes (numeric, alphanumeric, byte/binary, and kanji) to efficiently store data; extensions can also be used.
receive—to get as a signal, take, acquire, and/or obtain.
recommend—to suggest, praise, commend, and/or endorse.
render—to make perceptible to a human, for example as data, commands, text, graphics, audio, video, animation, and/or hyperlinks, etc., such as via any visual, audio, and/or haptic means, such as via a display, monitor, electric paper, ocular implant, cochlear implant, speaker, etc.
repeatedly—again and again; repetitively.
request—to express a desire for and/or ask for.
scan—to read data for use by an information device.
select—to choose from a plurality of alternatives.
sensor—a device used to measure a physical quantity (e.g., temperature, pressure, capacitance, and/or loudness, etc.) and convert that physical quantity into a signal of some kind (e.g., voltage, current, power, etc.). Such devices can comprise, for example, pulse detectors, blood pressure monitors, temperature measuring devices, electro cardiograms, and/or blood oxygen monitors, etc.
server—an information device and/or software that provides some service for other connected information devices via a network.
set—a related plurality.
signal—information, such as machine instructions for activities and/or one or more letters, words, characters, symbols, signal flags, visual displays, and/or special sounds, etc. having prearranged meaning, encoded as automatically detectable variations in a physical variable, such as a pneumatic, hydraulic, acoustic, fluidic, mechanical, electrical, magnetic, optical, chemical, and/or biological variable, such as power, energy, pressure, flowrate, viscosity, density, torque, impact, force, frequency, phase, voltage, current, resistance, magnetomotive force, magnetic field intensity, magnetic field flux, magnetic flux density, reluctance, permeability, index of refraction, optical wavelength, polarization, reflectance, transmittance, phase shift, concentration, and/or temperature, etc. Depending on the context, a signal and/or the information encoded therein can be synchronous, asynchronous, hard real-time, soft real-time, non-real time, continuously generated, continuously varying, analog, discretely generated, discretely varying, quantized, digital, broadcast, multicast, unicast, transmitted, conveyed, received, continuously measured, discretely measured, processed, encoded, encrypted, multiplexed, modulated, spread, de-spread, demodulated, detected, de-multiplexed, decrypted, and/or decoded, etc.
smartphone—a mobile phone (also known as cell phones) with an advanced mobile operating system that combines features of a personal computer operating system with other features useful for mobile or handheld use. Smartphones, combine the features of a mobile phone, such as the abilities to place and receive voice calls and create and receive text messages, with those of other popular digital mobile devices like personal digital assistants (PDAs), such as an event calendar, media player, video games, GPS navigation, digital camera, and/or digital video camera, etc. Smartphones can access the Internet and can run a variety of third-party software components (“apps”). Smartphones have a user interface that comprises a touchscreen, which enables the user to use a virtual keyboard to type words and numbers and press onscreen icons to activate “app” features.
SMS—a Short Message Service (“SMS”) is a text messaging service component of phone, Web, or mobile communication systems.
Staff Alert—an advisory message sent to an information device of a health care provider (e.g., via machine instructions such as an event monitoring system—“EMS”—PreAlert of Hewlett-Packard Corporation).
store—to place, hold, and/or retain data, typically in a memory.
substantially—to a great extent or degree.
system—a collection of mechanisms, devices, machines, articles of manufacture, processes, data, and/or instructions, the collection designed to perform one or more specific functions.
transfer table—a collection of related data about a patient that is held in a structured format.
transmit—to send as a signal, provide, furnish, and/or supply.
user interface—any device for rendering information to a user and/or requesting information from the user. A user interface includes at least one of textual, graphical, audio, video, animation, and/or haptic elements. A textual element can be provided, for example, by a printer, monitor, display, projector, etc. A graphical element can be provided, for example, via a monitor, display, projector, and/or visual indication device, such as a light, flag, beacon, etc. An audio element can be provided, for example, via a speaker, microphone, and/or other sound generating and/or receiving device. A video element or animation element can be provided, for example, via a monitor, display, projector, and/or other visual device. A haptic element can be provided, for example, via a very low frequency speaker, vibrator, tactile stimulator, tactile pad, simulator, keyboard, keypad, mouse, trackball, joystick, gamepad, wheel, touchpad, touch panel, pointing device, and/or other haptic device, etc. A user interface can include one or more textual elements such as, for example, one or more letters, number, symbols, etc. A user interface can include one or more graphical elements such as, for example, an image, photograph, drawing, icon, window, title bar, panel, sheet, tab, drawer, matrix, table, form, calendar, outline view, frame, dialog box, static text, text box, list, pick list, pop-up list, pull-down list, menu, tool bar, dock, check box, radio button, hyperlink, browser, button, control, palette, preview panel, color wheel, dial, slider, scroll bar, cursor, status bar, stepper, and/or progress indicator, etc. A textual and/or graphical element can be used for selecting, programming, adjusting, changing, specifying, etc. an appearance, background color, background style, border style, border thickness, foreground color, font, font style, font size, alignment, line spacing, indent, maximum data length, validation, query, cursor type, pointer type, autosizing, position, and/or dimension, etc. A user interface can include one or more audio elements such as, for example, a volume control, pitch control, speed control, voice selector, and/or one or more elements for controlling audio play, speed, pause, fast forward, reverse, etc. A user interface can include one or more video elements such as, for example, elements controlling video play, speed, pause, fast forward, reverse, zoom-in, zoom-out, rotate, and/or tilt, etc. A user interface can include one or more animation elements such as, for example, elements controlling animation play, pause, fast forward, reverse, zoom-in, zoom-out, rotate, tilt, color, intensity, speed, frequency, appearance, etc. A user interface can include one or more haptic elements such as, for example, elements utilizing tactile stimulus, force, pressure, vibration, motion, displacement, temperature, etc.
validate—to establish the soundness of.
via—by way of and/or utilizing.
vital sign—a physiological sign of life and usually an indicator of a person's general physical condition. Vital signs can include movement, blood temperature, blood pressure, body temperature, pulse rate, and/or respiratory rate, etc.
wireless—any means to transmit a signal that does not require the use of a wire connecting a transmitter and a receiver, such as radio waves, electromagnetic signals at any frequency, lasers, microwaves, etc., but excluding purely visual signaling, such as semophore, smoke signals, sign language, etc.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
no characteristic, function, activity, or element is “essential”;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A method comprising:
automatically assigning an emergency room suite based upon patient information, the patient information transmitted via a wireless signal from an emergency services entity to an entity managing the emergency room suite, the patient information comprising information inputted by one or more personnel of the emergency services entity, wherein:
machine instructions validate the patient information prior to transmittal of the wireless signal;
a server associated with the emergency room suite acknowledges receipt of the patient information and provides the emergency services entity with an incident number assigned to a patient based upon the patient information;
the server creates a history of the patient information and places the patient information in a transfer table; and
information from the transfer table is rendered to a first user.

2. The method of claim 1, further comprising:
causing a document associated with the patient to be scanned for a portion of the patient information.

3. The method of claim 1, further comprising:
causing a prescription associated with the patient to be scanned for a portion of the patient information.

4. The method of claim 1, further comprising:
causing sensor information associated with the patient to be automatically obtained for a portion of the patient information.

5. The method of claim 1, further comprising:
causing the patient to be placed in the emergency room suite upon arrival of the patient to a facility comprising the emergency room suite.

6. The method of claim 1, further comprising:
causing the patient information to be automatically erased from the transfer table.

7. The method of claim 1, further comprising:
automatically causing a Staff Alert to be transmitted based upon the patient information.

8. The method of claim 1, wherein:
the emergency room suite is approved by a second user entering approval via a user interface.

9. The method of claim 1, wherein:
the patient information comprises a vital sign of the patient.

10. The method of claim 1, wherein:
the patient information comprises a vital sign of the patient from a sensor via a Bluetooth signal.

11. The method of claim 1, wherein:
the wireless signal is transmitted via a smartphone.

12. The method of claim 1, wherein:
the patient is automatically assigned to a class of emergency patients based upon the patient information.

13. The method of claim 1, wherein:
causing information to be rendered to emergency room staff based upon the patient information.

14. The method of claim 1, wherein:
a facility comprising the emergency room suite is automatically selected based upon an automatically detected location of the patent and a location of the emergency room suite.
